(19) United States
(12) Patent Application Publication
(10) Pub. No.: US 2026/0225815 A1
(43) Pub. Date: Aug. 6, 2026

(54) MAINTENANCE CHAIN FOR CONVEYOR BELT

(71) Applicant: Solid Steel Solutions And Repair LLC, Wayland, MI (US)

(72) Inventor: Ryan Matthew Stewart, Wayland, MI (US)

(21) Appl. No.: 19/460,235

(22) Filed: Jan. 26, 2026

Related U.S. Application Data
(60) Provisional application No. 63/753,879, filed on Feb. 4, 2025.

(51) Int. Cl. B65G 17/08

(52) U.S. Cl. CPC B65G 17/08; B65G 2812/02396

(57) ABSTRACT

A modular chain assembly for conveyor belt maintenance includes a plurality of chain links. Each chain link includes a top plate and a bottom plate spaced apart from one another, a plurality of link arms extending between the top plate and the bottom plate at regular intervals along a length of the chain link, and a plurality of pin tabs extending outwardly from the link arms. Each pin tab includes a pin hole. Adjacent chain links are connected by pins inserted through aligned pin holes of the pin tabs, allowing the adjacent chain links to be rotatably secured to one another. The plurality of chain links are configured to be inserted into a conveyor belt system to create a maintenance access window.

### CROSS-REFERENCE TO RELATED APPLICATIONS

This application claims priority to U.S. Provisional Application No. 63/753,879, filed February 4, 2025, which is hereby incorporated by reference in its entirety.

### BACKGROUND

### Field of the Invention

The present disclosure relates to conveyor belt maintenance systems, and more particularly to a modular chain assembly designed to create a maintenance access window for servicing the underside of conveyor belts without extensive disassembly.

### Description of the Prior Art

Conveyor belt systems are widely utilized across numerous industries for efficient material handling and transportation. These systems play a substantial role in manufacturing, logistics, distribution centers, food processing, mining operations, and various other industrial settings where continuous operation is often required to maintain productivity. Conveyor belts are subject to wear and degradation due to constant use, exposure to environmental factors, and the weight of transported materials.

Maintenance of conveyor belt systems presents ongoing challenges for many industries. Regular inspections and repairs are performed to prevent unexpected breakdowns, ensure smooth operation, and extend the lifespan of the equipment. However, accessing certain parts of the conveyor system, particularly the underside of the belt, can be difficult and time-consuming with conventional approaches.

Traditional maintenance procedures often involve extensive disassembly of the conveyor belt system to access components underneath. This process can be labor-intensive, requiring multiple technicians and specialized tools. The downtime associated with such maintenance activities can lead to production losses and increased operational costs. Additionally, frequent assembly and disassembly of conveyor components may increase the risk of damage to the belt material and other sensitive parts.

There is a growing interest in more efficient and less disruptive maintenance solutions in the conveyor belt industry. Improved access to underside components without compromising the integrity of the entire system could potentially reduce maintenance time, minimize production interruptions, and enhance overall system reliability. Addressing these challenges could lead to improvements in the operational efficiency of facilities relying on conveyor belt systems.

### SUMMARY

According to an aspect of the present disclosure, a modular chain assembly for conveyor belt maintenance is provided. The modular chain assembly comprises a plurality of chain links. Each chain link includes a top plate and a bottom plate spaced apart from one another. A plurality of link arms extend between the top plate and the bottom plate at regular intervals along a length of the chain link. A plurality of pin tabs extend outwardly from the link arms, with each pin tab including a pin hole. Adjacent chain links are connected by pins inserted through aligned pin holes of the pin tabs, allowing the adjacent chain links to be rotatably secured to one another. The plurality of chain links are configured to be inserted into a conveyor belt system to create a maintenance access window.

According to other aspects of the present disclosure, the modular chain assembly may include one or more of the following features. Each chain link may further comprise a plurality of cog holes arranged in a linear pattern along the top plate, with the cog holes configured to engage with a sprocket system in the conveyor belt system. The cog holes may be rectangular and positioned in a symmetrical arrangement across a width of the top plate. Each chain link may further comprise an offset arm positioned adjacent to one of the link arms at an offset end of the chain link, with the offset arm facilitating an offset configuration for use in both right-handed and left-handed belt system applications. Adjacent chain links may be oriented in an alternating manner such that the offset end of one chain link is positioned adjacent to a non-offset end of a neighboring chain link, allowing the pin tabs of adjacent chain links to interleave and align for connection. The alternating orientation of adjacent chain links may enable the modular chain assembly to be universal for right-handed and left-handed belt system applications without requiring separate manufacturing configurations. Each pin may further comprise a pin head positioned on one end and a retaining clip on an opposite end to secure the connection between adjacent chain links. Each pin may include a plurality of retaining clips to ensure the pin remains secured if one retaining clip is missing. The plurality of chain links may comprise an even number of chain links, such as between 10 and 20 chain links. The chain links may be fabricated from metal selected from the group consisting of steel, stainless steel, and aluminum. The link arms may be oriented perpendicularly to the top plate and the bottom plate, and each link arm may include a pair of opposed pin tabs extending outwardly from opposite sides of the chain link.

According to another aspect of the present disclosure, a method of maintaining a conveyor belt system is provided. The method comprises removing a section of conveyor belt material from the conveyor belt system. The method further comprises inserting a modular chain assembly into the conveyor belt system in place of the removed section to create a maintenance access window, with the modular chain assembly comprising a plurality of interconnected chain links configured to engage with a sprocket system of the conveyor belt system. The method further comprises moving the maintenance access window along the conveyor belt system to access an underside of the conveyor belt. The method further comprises performing maintenance on the accessed underside of the conveyor belt. The method further comprises removing the modular chain assembly from the conveyor belt system.

According to other aspects of the present disclosure, the method may include one or more of the following features. Each chain link of the modular chain assembly may comprise a top plate and a bottom plate spaced apart from one another, a plurality of link arms extending between the top plate and the bottom plate at regular intervals along a length of the chain link, and a plurality of pin tabs extending outwardly from the link arms, with each pin tab including a pin hole configured to receive a pin for connecting adjacent chain links. Each chain link may further comprise a plurality of cog holes arranged in a linear pattern along the top plate, with the cog holes configured to engage with the sprocket system of the conveyor belt system. The method may further comprise aligning square cutouts on the chain links with corresponding features on an underside of the conveyor belt system prior to moving the maintenance access window along the conveyor belt system. Inserting the modular chain assembly may comprise installing two chain assemblies in a mirrored configuration on opposite sides of the conveyor belt system to form the maintenance access window therebetween.

According to another aspect of the present disclosure, a maintenance window assembly for a conveyor belt system is provided. The maintenance window assembly comprises a first chain assembly positioned on a first side of a conveyor belt. The maintenance window assembly further comprises a second chain assembly positioned on a second side of the conveyor belt opposite the first side. Each of the first chain assembly and the second chain assembly comprises a plurality of interconnected chain links, with each chain link including a top plate having a plurality of cog holes configured to engage with a sprocket system of the conveyor belt system. The first chain assembly and the second chain assembly are configured to create a maintenance access window between them for accessing an underside of the conveyor belt system.

According to other aspects of the present disclosure, the maintenance window assembly may include one or more of the following features. Each chain link may further comprise a bottom plate spaced apart from the top plate, and a plurality of link arms extending between the top plate and the bottom plate at regular intervals along a length of the chain link. Each chain link may further comprise a plurality of pin tabs extending outwardly from the link arms, with each pin tab including a pin hole, and adjacent chain links may be connected by pins inserted through aligned pin holes of the pin tabs. The first chain assembly and the second chain assembly may be positioned in a mirrored configuration on opposite sides of the conveyor belt, accommodating a width of the conveyor belt between them and allowing the maintenance access window to be moved along the conveyor belt to different locations.

For a more complete understanding, reference is made to the following detailed description and accompanying drawings. In the drawings, like reference characters refer to like parts throughout the views in which:

### BRIEF DESCRIPTION OF THE DRAWINGS

FIG. 1 illustrates an isometric view of a chain link for a modular belt assembly with a non-offset end of the chain link in the foreground and an offset end of the chain link in the background, in accordance with an embodiment of the disclosure;

FIG. 2 illustrates an isometric view of the chain link of FIG. 1 with the offset end of the chain link in the foreground and the non-offset end of the chain link in the background, in accordance with an embodiment of the disclosure;

FIG. 3 illustrates a side orthogonal view of the chain link of FIG. 1, in accordance with an embodiment of the disclosure;

FIG. 4 illustrates a front orthogonal view of the chain link of FIG. 1, in accordance with an embodiment of the disclosure;

FIG. 5 illustrates a top orthogonal view of the chain link of FIG. 1 showing a top plate, in accordance with an embodiment of the disclosure;

FIG. 6 illustrates an isometric view of a chain assembly comprising interconnected chain links, in accordance with an embodiment of the disclosure;

FIG. 7 illustrates a top orthogonal view of the chain assembly of FIG. 6, in accordance with an embodiment of the disclosure;

FIG. 8 illustrates a side orthogonal view of the chain assembly of FIG. 6, in accordance with an embodiment of the disclosure; and

FIG. 9 illustrates an isometric view of a maintenance window assembly integrated into a conveyor belt system, in accordance with an embodiment of the disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a modular chain assembly for conveyor belt maintenance. Conveyor belt systems are widely used in various industries for material handling and transportation, including manufacturing, logistics, and distribution centers. These systems require regular maintenance to prevent unexpected breakdowns, ensure smooth operation, and extend the lifespan of the equipment. However, accessing certain parts of the conveyor system, particularly the underside of the belt, can be difficult and time-consuming using traditional maintenance procedures.

Traditional maintenance procedures may require extensive disassembly of the conveyor belt system to access components underneath. This process can be labor-intensive, requiring multiple technicians and specialized tools. The downtime associated with such maintenance activities can lead to production losses and increased operational costs. Additionally, frequent assembly and disassembly of conveyor components may increase the risk of damage to the belt material and other parts.

The modular chain assembly described herein provides a solution for accessing and servicing various components of conveyor belts, particularly the underside, without the need for extensive disassembly of the entire system. The modular chain assembly may be configured to integrate with existing conveyor belt structures, allowing for maintenance procedures while reducing downtime.

In some cases, the modular chain assembly may comprise a series of interconnected chain links that can be inserted into a conveyor belt system to create a maintenance access window. The chain links may be designed to match the existing conveyor belt structure, enabling the chain links to engage with the conveyor system's components such as brackets and sprockets. The interconnected chain links may be individually connected, allowing the assembly to flex and conform to a path of the conveyor belt, including going around corners and transitioning from a top to a bottom of the belt.

The maintenance access window created by the modular chain assembly may be movable along the belt to different locations as needed, providing access to various parts of the system without repeated assembly and disassembly. In some cases, the modular chain assembly may be configured to allow access to both a top side and a bottom side of the conveyor belt. The modular chain assembly may be rolled up for storage and transportation when not in use.

Based upon the foregoing disclosure, it is seen that the present disclosure provides a modular chain assembly that offers advantages in conveyor belt maintenance. The assembly may allow for easier access to underside components, reducing maintenance time and improving overall system efficiency compared to traditional methods that require extensive disassembly. The modular nature of the assembly may also provide flexibility in application across various industries, making the assembly a versatile solution for a wide range of conveyor belt maintenance challenges. The ability to move the maintenance window along the conveyor belt without repeated assembly and disassembly may further reduce downtime and operational costs associated with conveyor system maintenance.

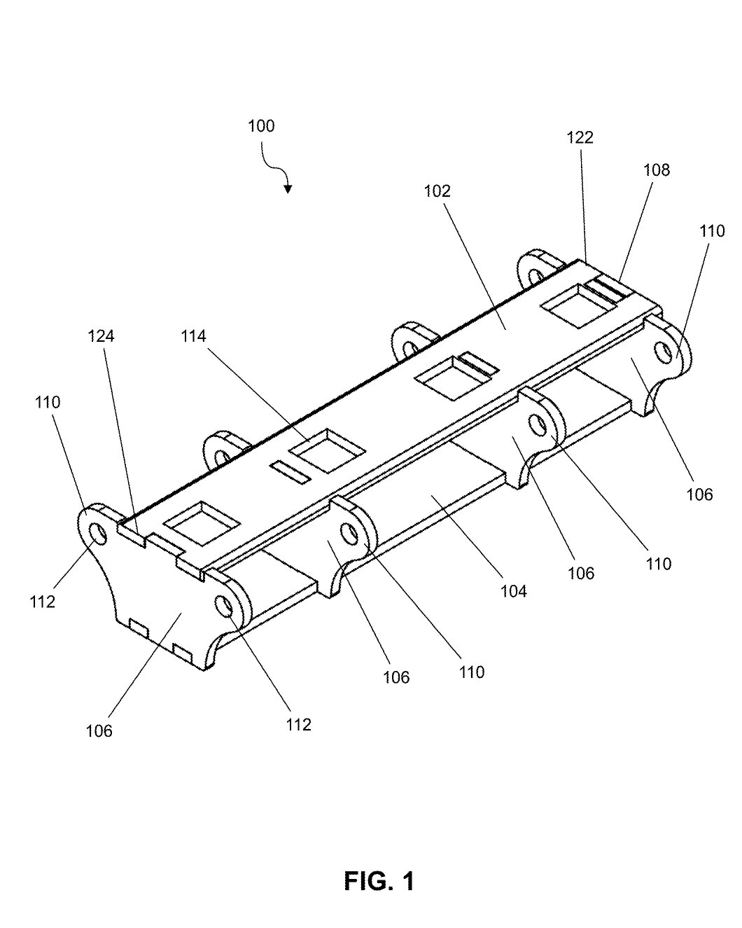

Referring to FIG. 1, a chain link 100 for use in a modular chain assembly is illustrated. The chain link 100 includes a top plate 102 and a bottom plate 104 spaced apart from one another. The top plate 102 may be positioned as an upper surface of the chain link 100, while the bottom plate 104 may be arranged in a parallel configuration beneath the top plate 102. In some cases, the top plate 102 and the bottom plate 104 may be oriented parallel to one another, though other configurations are possible. The top plate 102 and the bottom plate 104 may define an overall planar structure of the chain link 100.

A plurality of link arms 106 may extend between the top plate 102 and the bottom plate 104 at regular intervals along a length of the chain link 100. The link arms 106 may provide structural connection between the top plate 102 and the bottom plate 104, maintaining the spaced apart relationship between the two plates. In some cases, the link arms 106 may extend across a width of the chain link 100, connecting the top plate 102 to the bottom plate 104 at each interval position.

With continued reference to FIG. 1, the link arms 106 may be oriented perpendicularly to the top plate 102 and the bottom plate 104. This perpendicular orientation of the link arms 106 may provide structural support for the chain link 100 while maintaining the spaced apart relationship between the top plate 102 and the bottom plate 104. The link arms 106 may feature curved profiles that transition between the top plate 102 and the bottom plate 104.

The chain link 100 structure described herein may be used in various configurations. In some cases, the chain link 100 may form part of a modular chain assembly for conveyor belt maintenance. In other cases, the chain link 100 may be incorporated into a maintenance window assembly configured to create an access opening in a conveyor belt system. The arrangement of the top plate 102, the bottom plate 104, and the link arms 106 may allow the chain link 100 to be connected to adjacent chain links to form a flexible assembly capable of conforming to a conveyor belt path.

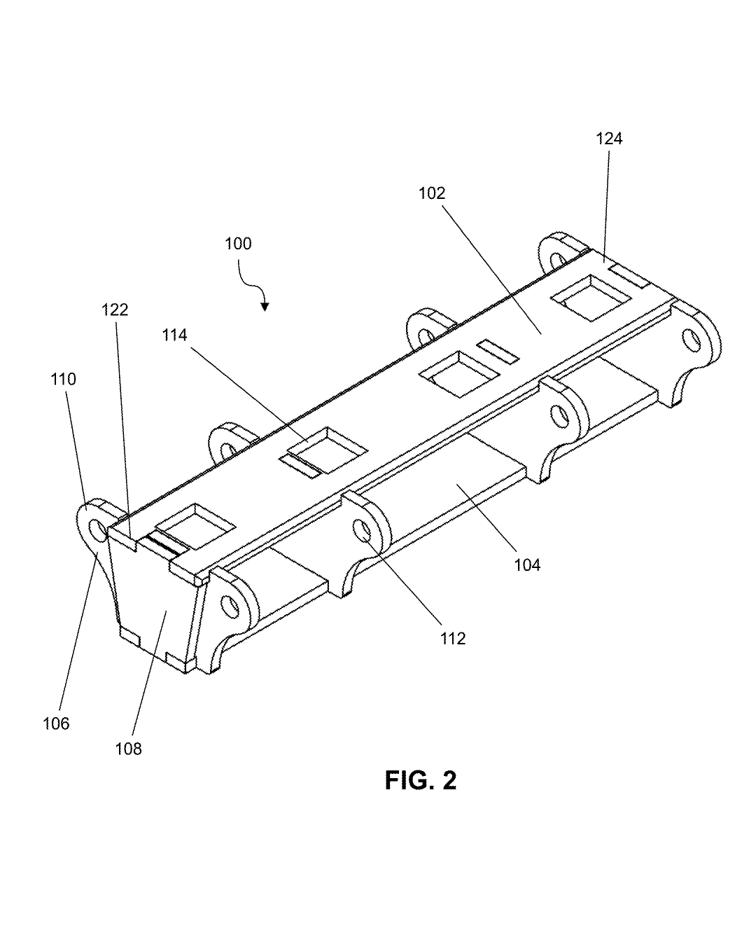

Referring to FIG. 2, each link arm 106 includes a pair of opposed pin tabs 110 extending outwardly from opposite sides of the chain link 100. The pin tabs 110 are arranged symmetrically on both sides of the chain link 100, with each pin tab 110 positioned at an end of a respective link arm 106. Each pin tab 110 includes a pin hole 112 configured to receive a pin for connecting adjacent chain links 100. The pin holes 112 may be circular apertures formed through the pin tabs 110, with the pin holes 112 of opposed pin tabs 110 on the same link arm 106 being coaxially aligned.

With continued reference to FIG. 2, the plurality of pin tabs 110 extending outwardly from the link arms 106 facilitate the connection of adjacent chain links 100 in a chain assembly. When two chain links 100 are positioned adjacent to one another, the pin tabs 110 of one chain link 100 interleave with the pin tabs 110 of the neighboring chain link 100. The pin holes 112 of the interleaved pin tabs 110 align to form a continuous passage through which a pin may be inserted. Adjacent chain links 100 are connected by pins inserted through aligned pin holes 112 of the pin tabs 110, allowing the adjacent chain links 100 to be rotatably secured to one another. This rotatable connection enables the chain assembly to flex and articulate as the assembly moves along a conveyor belt path, including transitioning around corners and rollers.

As further shown in FIG. 2, the arrangement of the pin tabs 110 and pin holes 112 provides a connection mechanism that maintains structural integrity while permitting relative rotation between adjacent chain links 100. The pin tabs 110 extend outwardly from the link arms 106 at a distance sufficient to allow the pin tabs 110 of adjacent chain links 100 to overlap and interleave when the chain links 100 are assembled. This configuration allows the chain assembly to conform to the path of a conveyor belt system, including bending around sprockets and transitioning between the top and bottom sides of the conveyor belt.

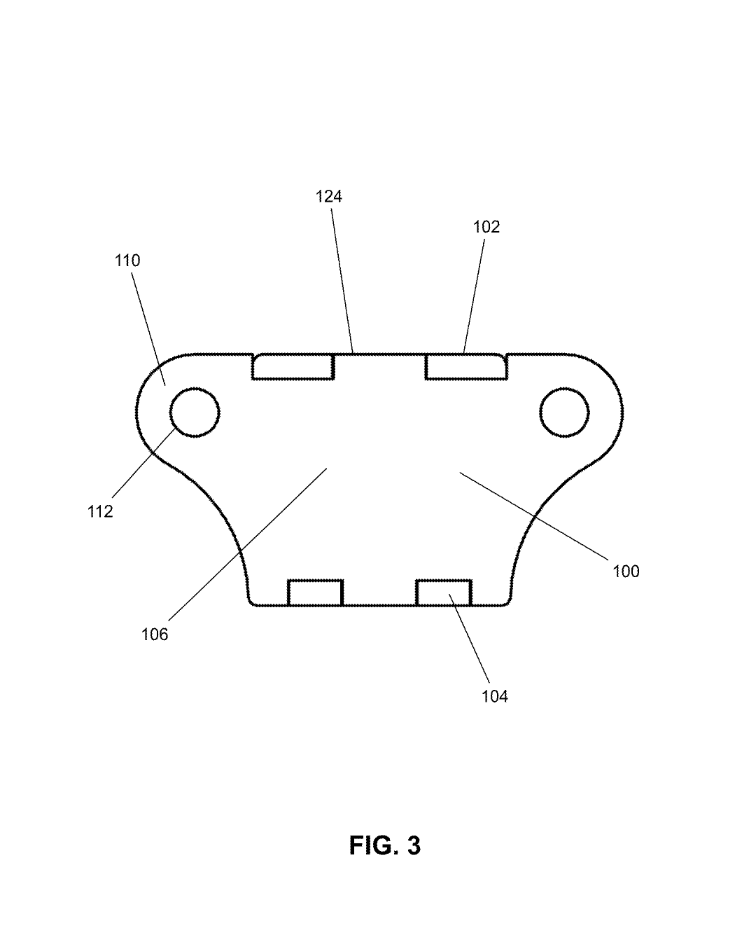

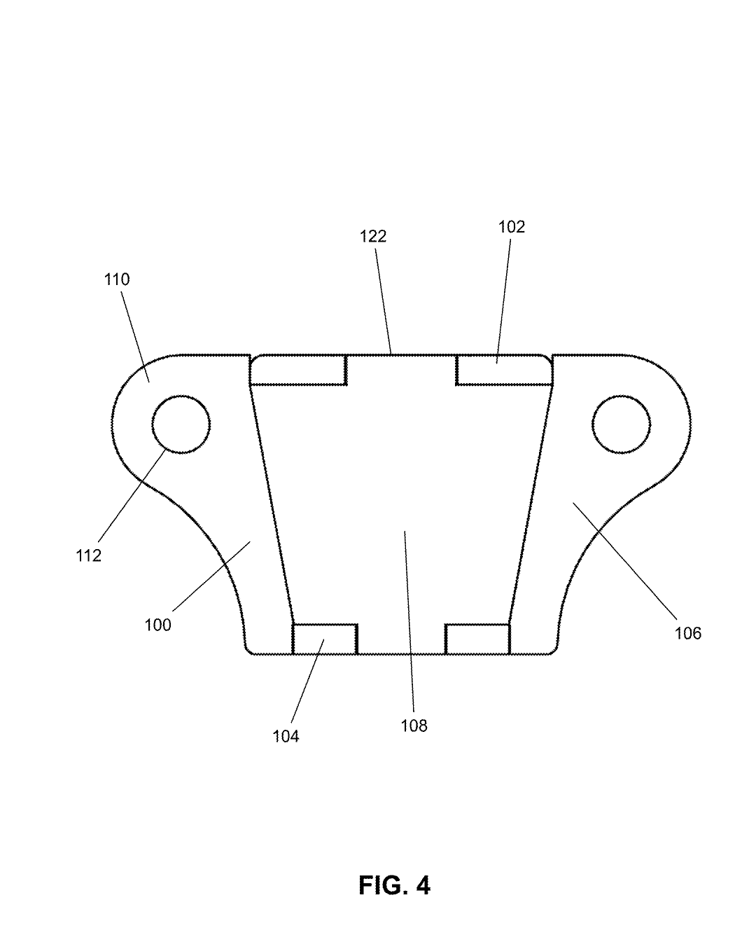

Referring to FIG. 1, FIG. 2, FIG. 3, and FIG. 4, each chain link 100 may include an offset arm 108 positioned adjacent to one of the link arms 106. The offset arm 108 may be located at an offset end 122 of the chain link 100. The chain link 100 may include a non-offset end 124 positioned opposite the offset end 122. The offset arm 108 may provide additional structural support and may facilitate an offset configuration that allows the chain link 100 to be used in both right-handed and left-handed belt system applications. FIG. 1 and FIG. 2 illustrate the same chain link 100 from opposite ends. FIG. 1 shows the chain link 100 with the non-offset end 124 in the foreground and the offset end 122 in the background, while FIG. 2 shows the same chain link 100 with the offset end 122 in the foreground and the non-offset end 124 in the background.

With continued reference to FIG. 3 and FIG. 4, the link arm 106 of the chain link 100 may be formed as one continuous piece. This configuration may reduce the number of pieces in the design and may minimize weld area. Reducing the weld area may cause less heat to be inducted into the assembly, which may keep the chain link 100 from warping out of tolerance during manufacturing.

As shown in FIG. 4, adjacent chain links 100 may be oriented in an alternating manner such that the offset end 122 of one chain link 100 is positioned adjacent to the non-offset end 124 of a neighboring chain link 100. This alternating arrangement may allow the pin tabs 110 of adjacent chain links 100 to interleave and align for connection. The interleaving of the pin tabs 110 may enable the pin holes 112 of adjacent chain links 100 to align, allowing pins to pass through the aligned pin holes 112 to secure the chain links 100 together.

The alternating orientation of adjacent chain links 100 may enable the modular chain assembly to be universal for right-handed and left-handed belt system applications without requiring separate manufacturing configurations. In some cases, moving a chain link 100 from one side of the chain assembly to the other may cause the offsetting to switch from right-to-left to left-to-right, or vice versa. This universal design may eliminate the need to manufacture chain links 100 in separate configurations for different belt system orientations, as the same chain link 100 may be used in either right-handed or left-handed applications by repositioning the chain link 100 within the chain assembly.

Based upon the foregoing disclosure, it is seen that the present disclosure provides a modular chain assembly with an offset arm configuration that offers advantages in manufacturing efficiency and application versatility. The continuous one-piece link arm design reduces manufacturing complexity by minimizing weld area and reducing the risk of heat-induced warping during fabrication. The offset arm configuration enables the chain links to be used universally in both right-handed and left-handed belt system applications without requiring separate manufacturing processes or inventory management for different configurations. The alternating orientation of adjacent chain links allows the pin tabs to interleave and align for connection, providing a secure and articulated connection between chain links while maintaining the universal applicability of the modular chain assembly across different conveyor belt system orientations.

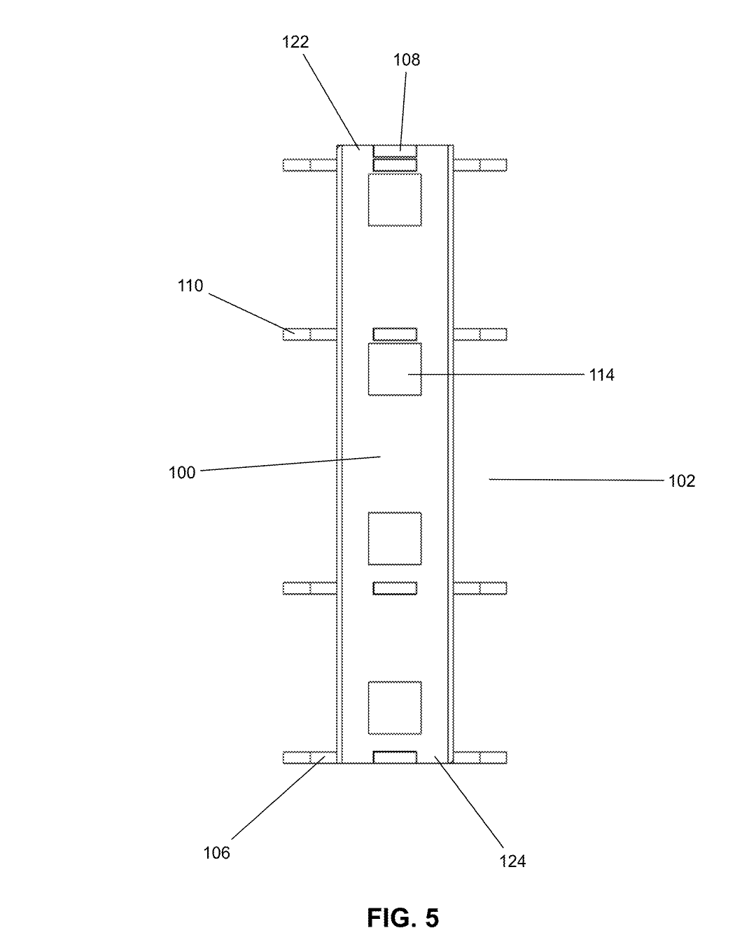

Referring to FIG. 5, the top plate 102 of each chain link 100 includes a plurality of cog holes 114 arranged in a linear pattern along the length of the top plate 102. The cog holes 114 may be rectangular in shape and positioned in a symmetrical arrangement across a width of the top plate 102. In some cases, the cog holes 114 are configured to engage with a sprocket system in the conveyor belt system, enabling the chain link 100 to be driven by the sprocket mechanism when installed in the conveyor system.

With continued reference to FIG. 5, the rectangular configuration of the cog holes 114 may allow the cog holes 114 to receive teeth or projections of the sprocket system as the chain assembly 200 moves along the conveyor belt path. The symmetrical arrangement of the cog holes 114 across the width of the top plate 102 may facilitate consistent engagement with the sprocket system regardless of the orientation of the chain link 100 within the conveyor belt system. In some cases, the linear pattern of the cog holes 114 along the top plate 102 corresponds to the spacing of sprocket teeth in the conveyor belt system, allowing the chain assembly 200 to be driven at the same rate as the surrounding conveyor belt 400 material.

In a method of maintaining a conveyor belt system, each chain link 100 may include a top plate 102 having a plurality of cog holes 114 configured to engage with a sprocket system of the conveyor belt system. The engagement between the cog holes 114 and the sprocket system may allow the maintenance window assembly 300 to be moved along the conveyor belt 400 to different locations as needed, providing access to various parts of the system without repeated assembly and disassembly of the modular chain assembly.

Based upon the foregoing disclosure, it is seen that the present disclosure provides a modular chain assembly having chain links with top plates featuring cog holes that engage with sprocket systems in conveyor belt systems. The cog hole configuration allows the chain assembly to be driven by existing sprocket mechanisms, enabling the maintenance window assembly to be repositioned along the conveyor belt path without manual manipulation. The rectangular shape and symmetrical arrangement of the cog holes across the width of the top plate provide consistent and reliable engagement with sprocket teeth, allowing the chain assembly to function seamlessly within the conveyor belt system during maintenance operations.

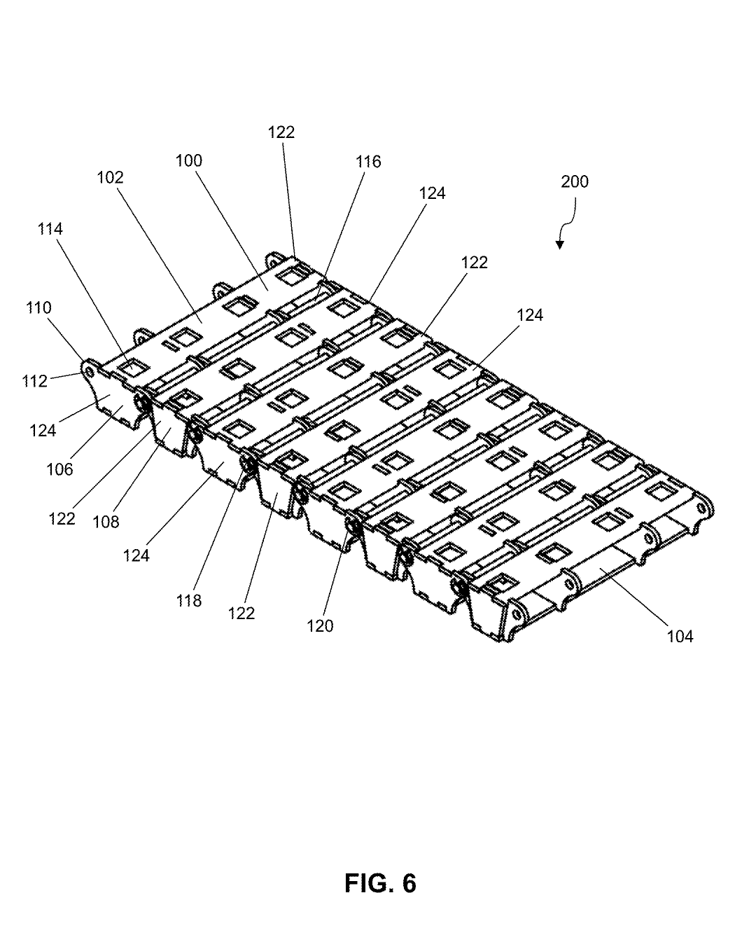

Referring to FIG. 6, a chain assembly 200 may comprise a plurality of interconnected chain links 100 arranged in a linear configuration. The chain assembly 200 may include an even number of chain links 100, such as between 10 and 20 chain links 100, and in some cases, the chain assembly 200 may include 16 chain links 100. The even number of chain links 100 maintains the alternating offset pattern required for proper alignment of the cog holes 114 with the driving sprockets of the conveyor belt system. An odd number of chain links 100 may disrupt the alternating pattern and cause misalignment between the chain assembly 200 and the conveyor belt system. Each chain link 100 in the chain assembly 200 may be connected to adjacent chain links 100 through pins 116 inserted through aligned pin holes 112 in the pin tabs 110 of neighboring chain links 100.

With continued reference to FIG. 6, adjacent chain links 100 in the chain assembly 200 may be oriented in an alternating manner such that the offset end 122 of one chain link 100 is positioned adjacent to the non-offset end 124 of a neighboring chain link 100. This alternating arrangement may allow the pin tabs 110 of adjacent chain links 100 to interleave and align for connection. The interleaving configuration of the pin tabs 110 may enable the pins 116 to pass through the aligned pin holes 112 of the interleaved pin tabs 110, thereby securing adjacent chain links 100 together while permitting articulated movement between the chain links 100.

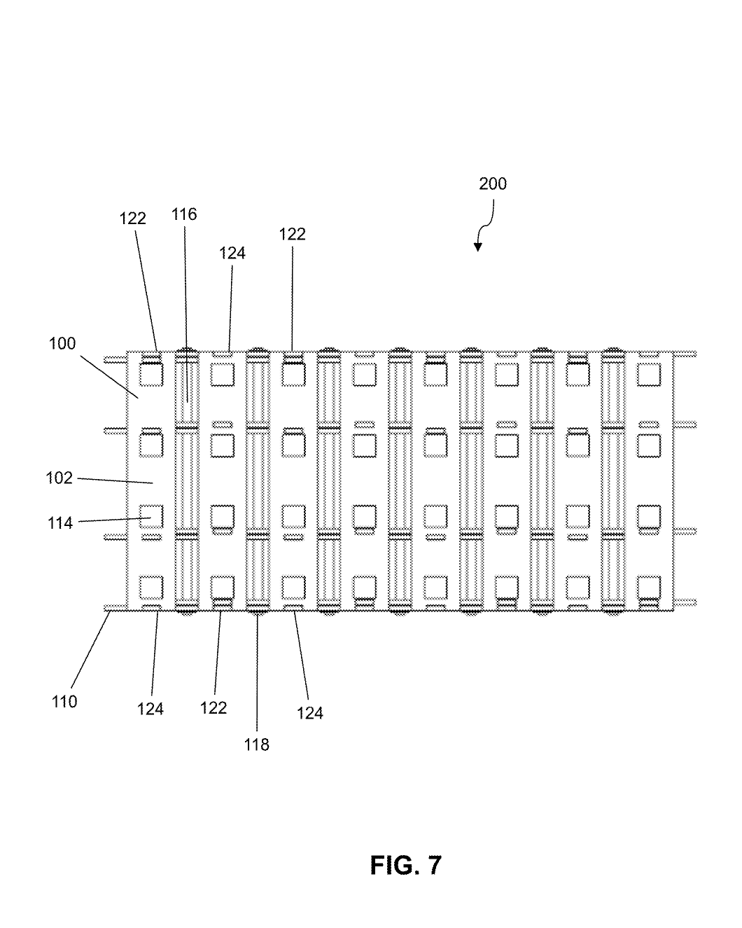

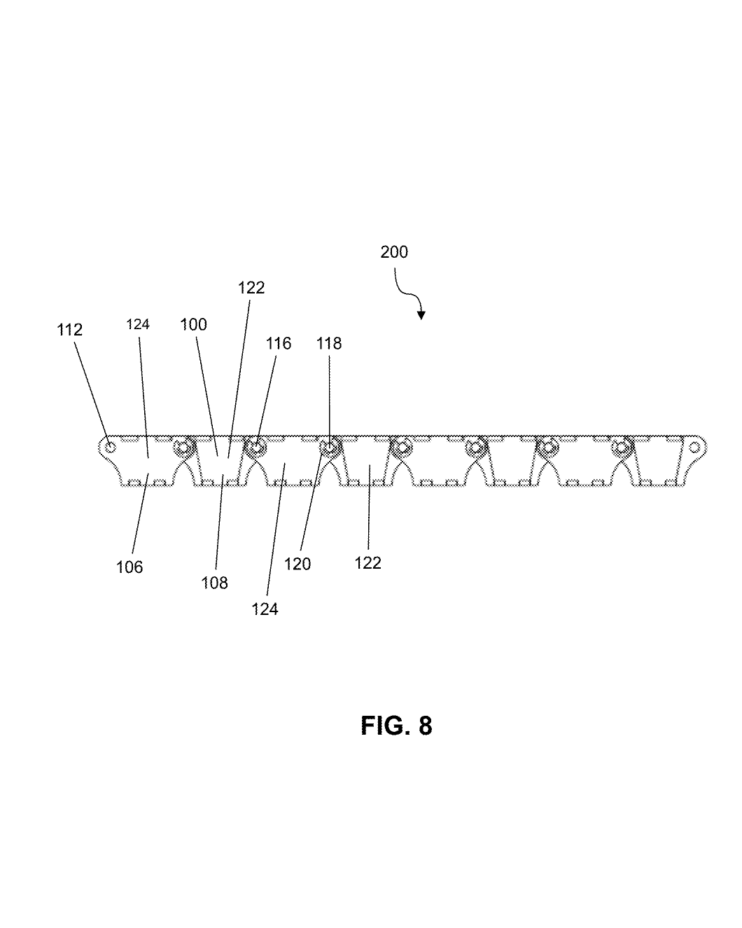

With continued reference to FIG. 6, FIG. 7, and FIG. 8, the offset arm 108 creates a spatial shift in the positioning of the link arms 106 and their associated pin tabs 110 along the length of the chain link 100. The presence of the offset arm 108 at the offset end 122 of the chain link 100 effectively staggers the placement of the link arms 106, creating gaps or spaces between the pin tabs 110 on one side of the chain link 100. When adjacent chain links 100 are oriented in an alternating manner such that the offset end 122 of one chain link 100 is positioned adjacent to the non-offset end 124 of a neighboring chain link 100, the pin tabs 110 of one chain link 100 are positioned to fit into the gaps between the pin tabs 110 of the neighboring chain link 100. This interleaving of the pin tabs 110 allows the pin holes 112 of the aligned pin tabs 110 to form a continuous passage configured to receive a pin 116, thereby securing adjacent chain links 100 together while permitting articulated movement between the chain links 100.

As further shown in FIG. 6, the plurality of chain links 100 in the chain assembly 200 may be configured to be inserted into a conveyor belt system to create a maintenance access window. The chain assembly 200 may form part of a maintenance window assembly, wherein a first chain assembly and a second chain assembly may each comprise a plurality of interconnected chain links 100. The first chain assembly and the second chain assembly may be positioned on opposite sides of a conveyor belt to define the maintenance access window therebetween. The alternating orientation of the chain links 100 within each chain assembly 200 may allow the chain assembly 200 to flex and conform to the path of the conveyor belt, including transitioning around corners and moving between the top and bottom sides of the conveyor system.

Referring to FIG. 7 and FIG. 8, the chain links 100 of the chain assembly 200 may be connected using a pin 116 inserted through the pin holes 112 in the pin tabs 110 of adjacent chain links 100. Each pin 116 may include a pin head 118 positioned on one end and a retaining clip 120 on an opposite end to secure the connection between adjacent chain links 100. The pin head 118 may be configured to prevent the pin 116 from passing entirely through the aligned pin holes 112, while the retaining clip 120 may be configured to engage with the pin 116 on the opposite end to retain the pin 116 in position within the pin holes 112.

With continued reference to FIG. 8, each pin 116 may include a plurality of retaining clips 120 to ensure the pin 116 remains secured if one retaining clip 120 is missing. The plurality of retaining clips 120 may provide redundancy in the connection mechanism, such that if one retaining clip 120 were to become dislodged or damaged during operation or handling, the remaining retaining clips 120 may continue to secure the pin 116 within the chain assembly 200. This configuration may prevent the pin 116 from shifting or falling out of the chain assembly 200 during use.

As further shown in FIG. 7 and FIG. 8, the retaining clips 120 may be configured to handle lateral forces applied to the chain assembly 200 while the chain assembly 200 is being handled during installation. The pin 116 may extend as a single longer pin through the aligned pin holes 112 of adjacent chain links 100, rather than using two shorter pins. This single longer pin configuration, combined with the plurality of retaining clips 120, may improve the reliability of the chain assembly 200 by providing a more secure connection between adjacent chain links 100 during installation and operation within a conveyor belt system.

Based upon the foregoing disclosure, it is seen that the present disclosure provides a modular chain assembly with an improved pin connection mechanism that enhances reliability and durability. The pin design featuring a pin head on one end and a plurality of retaining clips on the opposite end provides redundancy that prevents pin displacement even if one retaining clip is missing. The retaining clips are configured to withstand lateral forces encountered during installation and handling, and the use of a single longer pin rather than two shorter pins further improves the structural integrity of the chain assembly. These features collectively reduce the risk of chain assembly failure during maintenance operations on conveyor belt systems.

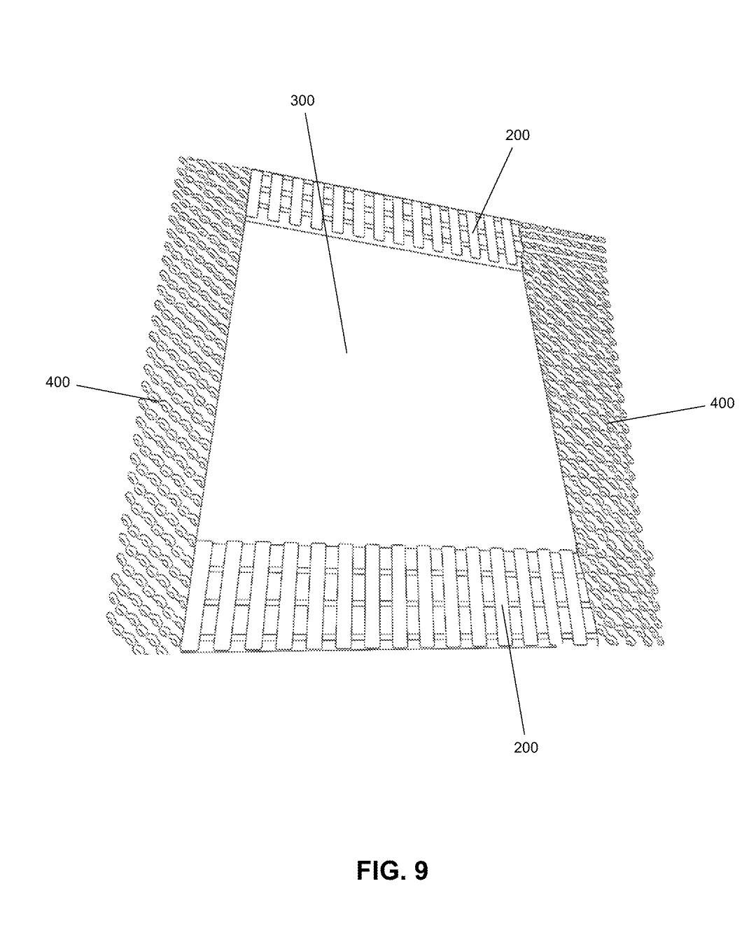

Referring to FIG. 9, a maintenance window assembly 300 may be configured for integration into a conveyor belt 400 system to facilitate maintenance access. The maintenance window assembly 300 may comprise a first chain assembly 200 positioned on a first side of the conveyor belt 400 and a second chain assembly 200 positioned on a second side of the conveyor belt 400 opposite the first side. The first chain assembly 200 and the second chain assembly 200 may be configured to create a maintenance access window between them for accessing an underside of the conveyor belt 400 system.

With continued reference to FIG. 9, the first chain assembly 200 and the second chain assembly 200 may be positioned in a mirrored configuration on opposite sides of the conveyor belt 400. In some cases, the mirrored configuration accommodates a width of the conveyor belt 400 between the first chain assembly 200 and the second chain assembly 200. The maintenance window assembly 300 may include two separate chain assemblies 200, with one chain assembly 200 on each side of the conveyor belt 400, allowing accommodation of different widths of conveyor belts. As further shown in FIG. 9, the first chain assembly 200 and the second chain assembly 200 replace sections of the conveyor belt 400 material to form an open rectangular window that provides access to the underside of the conveyor belt 400 system.

The maintenance window assembly 300 may be configured to allow the maintenance access window to be moved along the conveyor belt 400 to different locations. In some cases, the first chain assembly 200 and the second chain assembly 200 are designed to match the existing conveyor belt 400 structure, allowing the chain assemblies 200 to be inserted into the conveyor belt 400 system and to engage with sprocket systems of the conveyor belt 400 system. The maintenance window assembly 300 may be configured to allow the first chain assembly 200 and the second chain assembly 200 to flex and conform to a path of the conveyor belt 400, including transitioning around corners and moving between a top side and a bottom side of the conveyor belt 400 system. In some cases, the maintenance window assembly 300 enables maintenance personnel to access both the top side and the bottom side of the conveyor belt 400 through the opening created by the maintenance access window without repeated assembly and disassembly of the maintenance window assembly 300.

Based upon the foregoing disclosure, it is seen that the present disclosure provides a maintenance window assembly that offers advantages for conveyor belt maintenance across various industries. The maintenance window assembly surpasses prior art solutions by allowing access to both the top and bottom sides of the conveyor belt, eliminating the need for complete disassembly of large sections during maintenance. The maintenance window assembly reduces maintenance time from many hours or days to a fraction of that time by providing a movable maintenance access window that can be repositioned along the conveyor belt to access different portions of the underside without repeated assembly and disassembly. The accommodation of different conveyor belt widths through the mirrored configuration of the two chain assemblies provides flexibility for use across diverse conveyor belt systems in various industrial settings.

A method of maintaining a conveyor belt system may comprise removing a section of conveyor belt material from the conveyor belt system. The section of conveyor belt material removed may be equal in length to a modular chain assembly that will be installed in place of the removed section. In some cases, the removed section may correspond to an even number of chain links, where one chain link is the same length as one section of conveyor belt material.

The method may further comprise inserting a modular chain assembly into the conveyor belt system in place of the removed section to create a maintenance access window. The modular chain assembly may comprise a plurality of interconnected chain links configured to engage with a sprocket system of the conveyor belt system. In some cases, inserting the modular chain assembly comprises installing two chain assemblies in a mirrored configuration on opposite sides of the conveyor belt system to form the maintenance access window therebetween. The two chain assemblies may be positioned to mirror each other on either side of the conveyor belt system, with the maintenance access window formed in the space between the two chain assemblies.

Prior to moving the maintenance access window along the conveyor belt system, the method may further comprise aligning square cutouts on the chain links with corresponding features on an underside of the conveyor belt system. The square cutouts on bottom plates of the chain links may be configured to be installed inline with square openings on the underside of the conveyor belt system and inline with tooth gears on an end of a conveyor line. In some cases, the alignment may be adjusted by moving one chain link from one side of the chain assembly to the other while rotating the chain link 180 degrees. The alignment of the square cutouts with the corresponding features on the underside of the conveyor belt system may allow the modular chain assembly to properly engage with the sprocket system when the maintenance access window is moved along the conveyor belt system.

The method may further comprise moving the maintenance access window along the conveyor belt system to access an underside of the conveyor belt. The modular chain assembly may be configured to allow access to both a top side and a bottom side of the conveyor belt. The maintenance access window may be movable along the conveyor belt to different locations as needed, providing access to various parts of the conveyor belt system without repeated assembly and disassembly of the modular chain assembly. In some cases, the conveyor belt system may be jogged to move the maintenance access window along the conveyor belt system. The chain assembly may be jogged at a speed no faster than a walking pace during maintenance operations.

The method may further comprise performing maintenance on the accessed underside of the conveyor belt. Maintenance personnel may access components beneath the conveyor belt through the maintenance access window, including rollers, belts, and other conveyor system components. The maintenance access window may allow for inspection, cleaning, repair, and replacement of underside components without disassembling large sections of the conveyor belt system.

The method may further comprise removing the modular chain assembly from the conveyor belt system. After maintenance operations are complete, the chain assemblies may be disconnected from the conveyor belt system and the previously removed section of conveyor belt material may be reinstalled. The modular chain assembly may be rolled up for storage and transportation when not in use.

Based upon the foregoing disclosure, it is seen that the present disclosure provides a method of maintaining a conveyor belt system that allows for efficient access to underside components of conveyor systems without the need for extensive disassembly. The method surpasses prior art solutions by enabling the maintenance access window to be moved along the conveyor belt to different locations as needed, providing access to various parts of the system without repeated assembly and disassembly. The method further provides access to both the top side and the bottom side of the conveyor belt, addressing challenges of maintaining complex conveyor belt systems in environments where efficient maintenance reduces downtime and improves operational efficiency.

The chain links may be fabricated from a variety of materials depending on the operational requirements and environmental conditions of the conveyor belt system. In some cases, the chain links are fabricated from metal selected from the group consisting of steel, stainless steel, and aluminum. Steel provides durability and strength for general industrial applications. Stainless steel offers corrosion resistance suitable for environments where moisture or chemical exposure may occur. Aluminum provides a lighter weight alternative while maintaining structural integrity.

In some cases, the chain links may be fabricated from a specific stainless steel material specification, such as 10GA 304SS 2B stainless steel. The 10GA designation refers to the gauge thickness of the material, while 304SS indicates a grade of stainless steel containing chromium and nickel for enhanced corrosion resistance. The 2B finish designation refers to a smooth, reflective surface finish achieved through cold rolling and annealing processes.

For applications requiring a higher strength-to-weight ratio, the chain links may be fabricated from a titanium alloy. Titanium alloys offer reduced weight compared to steel while maintaining comparable or superior strength characteristics, which may be advantageous in applications where minimizing the overall weight of the modular chain assembly is desirable.

In harsh chemical environments, the chain links may be fabricated from a corrosion-resistant nickel alloy. Nickel alloys provide enhanced resistance to chemical attack and oxidation, making such materials suitable for conveyor systems operating in chemical processing facilities, food processing plants with aggressive cleaning agents, or other environments where exposure to corrosive substances may occur.

The pins connecting the chain links may be fabricated from materials different from the chain links themselves to optimize wear resistance at the connection points. In some cases, the pins may be made from ceramic composites for improved wear resistance. Ceramic composite pins offer hardness and abrasion resistance that may exceed metallic alternatives, potentially extending the service life of the modular chain assembly by reducing wear at the articulating joints between adjacent chain links.

Based upon the foregoing disclosure, it is seen that the present disclosure provides a modular chain assembly with material options that allow customization for diverse operational environments. The availability of multiple material choices, including steel, stainless steel, aluminum, titanium alloys, and nickel alloys for the chain links, along with ceramic composite options for the pins, enables the modular chain assembly to be configured for applications ranging from standard industrial conveyor systems to specialized environments requiring enhanced corrosion resistance, reduced weight, or improved wear characteristics.

In some cases, the middle sections of chain links may be designed with a skeletal structure that reduces weight while preserving strength. The skeletal structure may include openings, cutouts, or reduced material sections positioned between structural support members of the chain link. The skeletal configuration may maintain the structural integrity of the chain link while decreasing the overall mass of the chain assembly. The reduced weight may facilitate easier handling, storage, and transportation of the chain assembly when not in use.

In some cases, the middle pieces of chain links may have a more two-dimensional or flat structure. The flat structure may comprise a narrow plate with structure on sides or ends configured to receive pins used to secure adjacent pieces to one another. The narrow plate configuration may simplify the manufacturing process while maintaining the ability of the chain links to bend and rotate around corners and rollers in a conveyor belt system. The two-dimensional middle section design may reduce material usage and manufacturing complexity compared to more elaborate three-dimensional configurations.

In some cases, chain links may incorporate a modular design allowing for easy replacement of individual components without disassembling an entire chain assembly. The modular configuration may enable maintenance personnel to remove and replace a single chain link or component while leaving the remaining chain links connected and in position. The modular design may reduce maintenance time and minimize disruption to conveyor belt operations during repair or replacement procedures. Individual chain link components may be interchangeable, allowing for standardized replacement parts to be used across multiple chain assemblies.

In some cases, a chain assembly may require four chain links per assembly unit. The four chain link configuration may provide a standardized assembly unit that can be combined with additional assembly units to create chain assemblies of varying lengths. The assembly unit configuration may facilitate inventory management and allow for consistent manufacturing of chain assembly components.

In some cases, alternative connection mechanisms may be employed to join adjacent chain links in place of pins. For example, interlocking dovetail joints may be used to connect adjacent chain links. The interlocking dovetail joints may comprise a dovetail-shaped protrusion on one chain link configured to engage with a corresponding dovetail-shaped recess on an adjacent chain link. The interlocking dovetail joints may provide a tool-less assembly option, allowing adjacent chain links to be connected without the use of separate fasteners or tools. The dovetail configuration may allow adjacent chain links to slide together in one direction while preventing separation in other directions, thereby securing the chain links to one another while still permitting articulated movement between the chain links.

In some cases, magnetic connections may be employed to secure adjacent chain links to one another. The magnetic connections may comprise magnets positioned on adjacent chain links in a configuration that allows the magnets to attract one another when the chain links are positioned in alignment. The magnetic connections may allow for rapid deployment and disassembly of the chain assembly, as the chain links may be connected or disconnected without the use of tools or separate fasteners. The magnetic connections may reduce maintenance time and improve ease of use when installing or removing the chain assembly from a conveyor belt system. In some cases, the magnets may be embedded within the chain link structure or attached to surfaces of the chain links configured to interface with adjacent chain links.

The chain links of the modular belt assembly may undergo various surface treatments to enhance performance characteristics during operation in conveyor belt systems. In some cases, a low-friction coating may be applied to surfaces of the chain links to reduce wear and improve movement of the chain assembly around corners and rollers. The low-friction coating may comprise materials such as polytetrafluoroethylene (PTFE), molybdenum disulfide, or other friction-reducing compounds that decrease resistance between the chain links and conveyor system components. Application of the low-friction coating may extend the operational lifespan of the chain assembly by minimizing abrasion and reducing heat generation during movement through the conveyor system.

In some cases, a textured surface treatment may be applied to specific areas of the chain links to increase grip where needed. The textured surface treatment may be positioned on portions of the chain links that contact other conveyor belt components or that require enhanced traction during operation. The textured surface treatment may comprise knurling, etching, or other surface modification techniques that create a roughened or patterned surface profile. The textured surface treatment may be selectively applied to areas such as contact surfaces between adjacent chain links or surfaces that engage with sprocket teeth, while other areas of the chain links may remain smooth or receive the low-friction coating. In some cases, the chain links may receive both the low-friction coating and the textured surface treatment on different portions of the chain links, with the low-friction coating applied to areas where reduced friction is desired and the textured surface treatment applied to areas where increased grip is beneficial.

In some cases, the chain assembly may incorporate integrated sensors to monitor various parameters during operation. The integrated sensors may provide data that can be used for predictive maintenance, reducing downtime and extending the lifespan of both the chain assembly and the conveyor system in which the chain assembly is installed.

In some cases, the chain assembly may incorporate integrated strain gauges configured to detect excessive stress on the chain links. The strain gauges may be attached to specific chain links at locations where stress concentrations are expected to occur during operation. The strain gauges may generate electrical signals proportional to the mechanical strain experienced by the chain links, and the electrical signals may be transmitted to a monitoring system for analysis. When the strain gauges detect stress levels exceeding a predetermined threshold, the monitoring system may generate an alert to notify maintenance personnel of a condition requiring attention.

In some cases, the chain assembly may incorporate integrated temperature sensors configured to alert for overheating conditions. The temperature sensors may be positioned at various locations along the chain assembly, such as on the top plates or bottom plates of the chain links, or in proximity to the pin connections between adjacent chain links. The temperature sensors may continuously monitor the temperature of the chain assembly during operation and may transmit temperature data to a monitoring system. When the temperature sensors detect temperatures exceeding a predetermined threshold, the monitoring system may generate an alert to notify maintenance personnel of a potential overheating condition that may require intervention.

In some cases, the chain assembly may incorporate integrated accelerometers configured to measure vibration during operation. The accelerometers may be positioned on select chain links to detect vibration patterns that may indicate abnormal operating conditions, such as misalignment, wear, or damage to the chain assembly or the conveyor system. The accelerometers may generate signals corresponding to the acceleration and vibration experienced by the chain links, and the signals may be transmitted to a monitoring system for analysis. The monitoring system may analyze the vibration data to identify patterns that may indicate developing problems, allowing maintenance personnel to address issues before failure occurs.

The chain assembly is configured to be rolled up for storage and transportation when not in use. The articulated connections between adjacent chain links allow the chain assembly to flex and curve, enabling the chain assembly to be coiled into a compact rolled configuration. This rolled configuration reduces the storage footprint of the chain assembly and facilitates transportation of the chain assembly to different locations within a facility or between facilities. When the chain assembly is needed for maintenance operations, the chain assembly may be unrolled and inserted into the conveyor belt system to create a maintenance access window. The ability to roll up the chain assembly provides convenience for maintenance personnel who may need to transport the chain assembly to various conveyor belt systems throughout a facility.

Based upon the foregoing disclosure, it is seen that the present disclosure provides a modular chain assembly that facilitates efficient maintenance of conveyor belt systems. The modular chain assembly allows access to both the top side and the bottom side of the conveyor belt without extensive disassembly of the conveyor system. Prior art solutions for conveyor belt maintenance often require complete disassembly of large sections of the conveyor belt to access components underneath, which is labor-intensive, requires multiple technicians and specialized tools, and results in significant production downtime. The modular chain assembly of the present disclosure eliminates the need for such extensive disassembly by providing a maintenance access window that can be inserted into the conveyor belt system and moved along the belt to different locations as needed.

The modular chain assembly reduces maintenance time compared to traditional maintenance procedures. By allowing maintenance personnel to access underside components through the maintenance window without removing large sections of the conveyor belt, the time required for routine inspections, repairs, and cleaning is substantially decreased. The ability to move the maintenance window along the conveyor belt path provides access to various parts of the system without repeated assembly and disassembly, further reducing the time spent on maintenance activities.

The modular chain assembly minimizes production interruptions by enabling maintenance to be performed more quickly and with less disruption to the overall conveyor system. The chain links are configured to flex and conform to the conveyor belt path, including transitioning around corners and moving between the top and bottom sides of the conveyor system, allowing the conveyor to continue operating in areas not being serviced. The reduced downtime associated with maintenance activities translates to improved operational efficiency and reduced production losses.

The modular chain assembly enhances overall system reliability by reducing the risk of damage to the conveyor belt material and other components that may occur during frequent assembly and disassembly operations. The chain links are fabricated from high-strength metal materials such as steel, stainless steel, or aluminum, providing durability for years of use with routine cleaning and general lubrication to the pins.

The universal design of the chain links for both right-handed and left-handed belt system applications eliminates the need for separate manufacturing configurations. The one-piece link arm design allows the chain links to be moved from one side of the assembly to the other, which causes the offsetting to switch between right-to-left and left-to-right configurations. This universal design reduces manufacturing complexity, minimizes inventory requirements, and provides flexibility in deployment across different conveyor system orientations.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A modular chain assembly for conveyor belt maintenance, comprising:
a plurality of chain links, each chain link including:
a top plate and a bottom plate spaced apart from one another;
a plurality of link arms extending between the top plate and the bottom plate at regular intervals along a length of the chain link; and
a plurality of pin tabs extending outwardly from the link arms, each pin tab including a pin hole;
wherein adjacent chain links are connected by pins inserted through aligned pin holes of the pin tabs, allowing the adjacent chain links to be rotatably secured to one another; and
wherein the plurality of chain links are configured to be inserted into a conveyor belt system to create a maintenance access window.

2. The modular chain assembly of claim 1, wherein each chain link further comprises a plurality of cog holes arranged in a linear pattern along the top plate, the cog holes configured to engage with a sprocket system in the conveyor belt system.

3. The modular chain assembly of claim 2, wherein the cog holes are rectangular and positioned in a symmetrical arrangement across a width of the top plate.

4. The modular chain assembly of claim 1, wherein each chain link further comprises an offset arm positioned adjacent to one of the link arms at an offset end of the chain link, the offset arm facilitating an offset configuration for use in both right-handed and left-handed belt system applications.

5. The modular chain assembly of claim 4, wherein adjacent chain links are oriented in an alternating manner such that the offset end of one chain link is positioned adjacent to a non-offset end of a neighboring chain link, allowing the pin tabs of adjacent chain links to interleave and align for connection.

6. The modular chain assembly of claim 5, wherein the alternating orientation of adjacent chain links enables the modular chain assembly to be universal for right-handed and left-handed belt system applications without requiring separate manufacturing configurations.

7. The modular chain assembly of claim 1, wherein each pin further comprises a pin head positioned on one end and a retaining clip on an opposite end to secure the connection between adjacent chain links.

8. The modular chain assembly of claim 7, wherein each pin includes a plurality of retaining clips to ensure the pin remains secured if one retaining clip is missing.

9. The modular chain assembly of claim 1, wherein the plurality of chain links comprises an even number of chain links between 10 and 20.

10. The modular chain assembly of claim 1, wherein the chain links are fabricated from metal selected from the group consisting of steel, stainless steel, and aluminum.

11. The modular chain assembly of claim 1, wherein the link arms are oriented perpendicularly to the top plate and the bottom plate, and wherein each link arm includes a pair of opposed pin tabs extending outwardly from opposite sides of the chain link.

12. A method of maintaining a conveyor belt system, comprising:
removing a section of conveyor belt material from the conveyor belt system;
inserting a modular chain assembly into the conveyor belt system in place of the removed section to create a maintenance access window, the modular chain assembly comprising a plurality of interconnected chain links configured to engage with a sprocket system of the conveyor belt system;
moving the maintenance access window along the conveyor belt system to access an underside of the conveyor belt;
performing maintenance on the accessed underside of the conveyor belt; and
removing the modular chain assembly from the conveyor belt system.

13. The method of claim 12, wherein each chain link of the modular chain assembly comprises:
a top plate and a bottom plate spaced apart from one another;
a plurality of link arms extending between the top plate and the bottom plate at regular intervals along a length of the chain link; and
a plurality of pin tabs extending outwardly from the link arms, each pin tab including a pin hole configured to receive a pin for connecting adjacent chain links.

14. The method of claim 13, wherein each chain link further comprises a plurality of cog holes arranged in a linear pattern along the top plate, the cog holes configured to engage with the sprocket system of the conveyor belt system.

15. The method of claim 14, further comprising aligning square cutouts on the chain links with corresponding features on an underside of the conveyor belt system prior to moving the maintenance access window along the conveyor belt system.

16. The method of claim 12, wherein inserting the modular chain assembly comprises installing two chain assemblies in a mirrored configuration on opposite sides of the conveyor belt system to form the maintenance access window therebetween.

17. A maintenance window assembly for a conveyor belt system, comprising:
a first chain assembly positioned on a first side of a conveyor belt; and
a second chain assembly positioned on a second side of the conveyor belt opposite the first side;
wherein each of the first chain assembly and the second chain assembly comprises a plurality of interconnected chain links, each chain link including a top plate having a plurality of cog holes configured to engage with a sprocket system of the conveyor belt system; and
wherein the first chain assembly and the second chain assembly are configured to create a maintenance access window between them for accessing an underside of the conveyor belt system.

18. The maintenance window assembly of claim 17, wherein each chain link further comprises a bottom plate spaced apart from the top plate, and a plurality of link arms extending between the top plate and the bottom plate at regular intervals along a length of the chain link.

19. The maintenance window assembly of claim 18, wherein each chain link further comprises a plurality of pin tabs extending outwardly from the link arms, each pin tab including a pin hole, and wherein adjacent chain links are connected by pins inserted through aligned pin holes of the pin tabs.

20. The maintenance window assembly of claim 17, wherein the first chain assembly and the second chain assembly are positioned in a mirrored configuration on opposite sides of the conveyor belt, accommodating a width of the conveyor belt between them and allowing the maintenance access window to be moved along the conveyor belt to different locations.
